(19) United States
(12) Patent Application Publication
(10) Pub. No.: US 2004/0050335 A1
(43) Pub. Date: Mar. 18, 2004

(54) Animal feed supplement containing d-pantothenic acid and/or its salts, improved method for the production thereof, and its use

(76) Inventors: Jurgen Muller, Ludwigshafen (DE); Knut Eichler, Singapore (SG)

Correspondence Address: KEIL & WEINKAUF, 1350 CONNECTICUT AVENUE, N.W., WASHINGTON, DC, 20036, US

(21) Appl. No.: 10/380,053

(22) PCT Filed: Sep. 8, 2001
(86) PCT No.: PCT/EP01/10386

(30) Foreign Application Priority Data
Sep. 20, 2000 (DE) 10046490.4
Mar. 14, 2001 (DE) 10112207.1

(51) Int. Cl. A01K 1/10; A01K 5/00; A01K 39/00

(52) U.S. Cl. 119/51.01

(57) ABSTRACT

The invention relates to an animal feed supplement containing free D-pantothenic acid and/or its salts, and to an improved method for the production thereof. The invention also relates to the use of the animal feed supplement in the field of animal feeding.

The present invention relates to an animal feed supplement containing D-pantothenic acid, to an improved method for the production thereof, and to the use thereof.

As a starting material in the biosynthesis of coenzyme A, D-pantothenate is widespread in the plant and animal kingdoms. In contrast to humans, who consume adequate amounts of pantothenic acid in the diet, manifestations of D-pantothenate deficiency have, however, frequently been described both for plants and for animals. The availability of D-pantothenate is therefore of great economic interest, especially in the animal feed industry.

D-pantothenate is conventionally produced by chemical synthesis from D-pantolactone and calcium β-alaninate (Ullmann's Encyclopedia of Industrial Chemistry, 6th edition, 1999, electronic release, chapter “Vitamins”). The provision of D-pantolactone requires an elaborate classical racemate resolution via diastereomeric salts. The marketed product resulting from the chemical synthesis is usually the calcium salt of D-pantothenic acid, calcium D-pantothenate.

Compared with chemical synthesis, the advantage of biotechnological production methods using microorganisms is the selective (enantiopure) provision of the D form of pantothenic acid which can be utilized by higher organisms. An elaborate racemate resolution as necessary in the chemical synthesis is thus unnecessary.

Many fermentative methods for producing D-pantothenic acid using microorganisms are known, inter alia from EP 0 590 857, WO 96/33283, U.S. Pat. No. 6,013,492, WO 97/10340, DE 198 46 499, EP 1 001 027, EP 1 006 189, EP 1 006 192 and EP 1 006 193.

Thus, GB 598,177 describes the preparation of pantothenic acid in the parts per thousand range as byproduct to the production of 2,3-butylene glycol by Aerobacter aerogenes. However, concentration of the pantothenic acid is possible only by adsorption onto wood charcoal and subsequent elution.

EP 1 006 189 [lacuna] a method for producing pantothenate in which a max. D-pantothenic acid content of 1 g/l is achieved in the fermentation solution. Such low pantothenic acid contents in the fermentation solution, i.e. less than 10% by weight based on the solids content, are, however, unsuitable for commercial production of animal feed supplements containing D-pantothenic acid. A further disadvantage of the methods described to date is that the isolation of the product from the fermentation medium requires a large number of elaborate workup steps. An economic method of production for the industrial scale has not been disclosed.

Thus, U.S. Pat. No. 6,013,492 describes the workup of D-pantothenic acid from the fermentation solution by filtering off insoluble constituents such as, for example, cell material from the culture medium, adsorption of the filtrate onto activated carbon, subsequent elution of the D-pantothenic acid with an organic solvent, preferably methanol, neutralization using calcium hydroxide and a final crystallization of calcium D-pantothenic acid. A considerable disadvantage of these elaborate workup steps is an additional loss of desired product. In addition, for production on the industrial scale, an additional system for recovering the solvent employed would be necessary. A further disadvantage is the additional production of large quantities of wastewater which itself requires costly treatment or even disposal.

DE 100 16 321 A1 discloses a method for producing animal feed additives which are produced by fermentation of D-pantothenic acid-producing microorganisms. However, this method requires the addition of hydroxides or oxides of alkali metals or alkaline earth metals after the fermentation.

It is thus an object of the present invention to provide an animal feed supplement containing free D-pantothenic acid and/or salts thereof, and the production thereof by an improved method which no longer has the aforementioned disadvantages.

This object is achieved in an advantageous manner by the present invention.

The invention relates to a method for the production of an animal feed supplement containing free D-pantothenic acid and/or salts thereof, where

a) a D-pantothenic acid-producing organism is fermented in a culture medium containing at least one carbon source and one nitrogen source without feeding with other precursors and

b) the fermentation solution containing D-pantothenic acid and/or salts thereof is subjected, without carrying out further workup steps, to a drying and/or formulation.

The method of the invention is distinguished further by carrying out the fermentation until a solids content of at least 6% by weight, preferably of 7-25% by weight and/or a D-pantothenic acid content of at least 2-15% by weight, preferably 4-15% by weight, is reached.

The fermentation for this purpose can be carried out by procedures known per se in batch, fed-batch or repeated fed-batch operation or in a continuous process. A solids content means for the purposes of the present invention the dried fermentation solution containing inter alia dried biomass, minerals and D-pantothenate and/or salts thereof. To determine the solids content, a sample of the fermentation solution is taken under sterile conditions and dried for example in a vacuum oven at 120° C. for 12 hours.

A particular advantage of the method of the invention compared with the prior art is that the fermentation solution need not be subjected to a further elaborate workup, such as, for example, adsorptive methods on activated carbon, in order to provide a product which meets the requirements of an animal feed supplement of the desired type. These requirements are, for example, a relatively high D-pantothenic acid content and good tolerability for the target organism, and a biological value in the sense of the “vitamin effect” of the product of the invention, which corresponds to the value of the chemically synthesized D-pantothenic acid.

The degree of purity of the D-pantothenic acid as such is to be regarded in this case as of minor importance because for animal feeding it is in most cases incorporated into compound feeds. On the contrary, it is to be regarded as a further advantage of the product of the invention precisely that, because of the aforementioned method of production, it contains in addition to D-pantothenic acid other constituents of the fermentation solution which are conducive to the wellbeing of the animals, such as, for example, a relatively high protein content, and (possibly essential) amino acids, minerals, vitamins and other constituents secreted into the medium where appropriate during the fermentation.

A further advantage of the method of the invention is the dispensing with elaborate workup steps on the fermentation solution to produce a product with good biological value. In particular, the method of the invention is distinguished by the desired material being provided entirely without the use of organic solvents. In addition, the amount of wastewater produced is considerably reduced according to the invention. This therefore results in further dispensing with elaborate workup and disposal systems. The method of the invention is thus distinguished in an advantageous manner by being simpler, less fault-liable, less time-consuming, distinctly less costly and thus more economic than conventional methods.

The word “produce” means according to the invention in this connection that the organism is able to synthesize larger amounts of D-pantothenic acid and/or salts thereof than are necessary for its own metabolic requirements. In a variant which is advantageous according to the invention, the synthesized amount of D-pantothenic acid and/or salts thereof is not present inside cells but is ideally released entirely from the organism into the culture medium. This exportation can take place actively or passively by mechanisms known per se.

The D-pantothenic acid-producing organisms employed according to the invention are microorganisms. These include according to the invention fungi, yeasts and/or bacteria. Preference is given according to the invention to the use of fungi such as, for example, Mucor or yeasts such as, for example, Saccharomyces or Debaromyces and, in this case, preferably Saccharaomyces [sic] cerevisiae. Coryneform bacteria or Bacillaceae are advantageously used according to the invention. Preferably included according to the invention are, for example, bacteria of the genera Corynebacterium, Escherichia, Bacillus, Arthrobacter, Bevibacterium [sic], Pseudomonas, Salmonella, Klebsiella, Proteus, Acinetobacter or Rhizobium. Particularly preferred examples in this connection are Corynebacterium glutamicum, Brevibacterium breve or Bacillus subtilis, B. licheniformis, B. amyloliquefaciens, B. cereus, B. lentimorbus, B. lentus, B. firmus, B. pantothenticus, B. circulans, B. coagulans, B. megaterium, B. pumilus, B. thuringiensis, B. brevis, B. stearothermophilus and other group 1 Bacillus species which are characterized by their 16sRNA [sic], or Actinum mycetalis. This list is illustrative and is in no way limiting for the present invention.

The present invention additionally includes the use of genetically modified organisms for the production according to the invention of an animal feed supplement containing free D-pantothenic acid and/or salts thereof. Such genetically modified organisms can be isolated for example by chemical mutagenesis and subsequent selection through a suitable “screening method”. The invention also includes so-called producer strains which are suitable for producing the product for the purposes of the present invention and have genetic modifications in relation to the metabolic flux in the direction of D-pantothenic acid, also including modifications in relation to the exportation of D-pantothenic acid and/or salts thereof through the cell membrane.

It is also conceivable to use transgenic organisms resulting from the transfer of homologous and/or heterologous nucleotide sequences which are necessary for or may promote the synthesis of the desired product. Overexpression and/or deregulation of one or more genes, singly and/or in combination, localized in the genome and/or on a vector, is conceivable in this connection.

Such transgenic organisms may in an advantageous manner contain additional copies and/or genetically modified genes selected from the group of panB, panC, panD, panE and/or combinations thereof and/or even organizational units such as the panBCD operon. A further possibility is to manipulate advantageously other metabolic pathways such as, for example, the isoleucine-valine biosynthetic pathway in the organisms, as described, for example, in EP 1 006 189, EP 1 006 192, EP 1 006 193 or EP 1 001 027. This increases the availability of branched-chain precursor substances of pantothenic acid biosynthesis. It is advantageous where appropriate for the genes for this biosynthetic pathway, i.e. ilvB, ilvN, ilvC and/or ilvD, to be overexpressed.

Additionally included according to the invention are genetic modifications of aspartate α-decarboxylase (panD), e.g. by overexpression and/or deregulation, in the D-pantothenic acid-producing organism employed. Thus, in an advantageous manner, β-alanine is already present in the cells in increased concentrations compared with correspondingly non-genetically modified organisms and thus need not be added to the culture medium as precursor, as described by way of example in EP-A-0 590 857. Advantageous microorganisms are those whose pantothenic acid (pan) and/or isoleucine-valine (ilv) biosynthesis and/or asparate [sic] α-decarboxylase (panD) is deregulated.

Additional overexpression of ketopanthoate [sic] reductase (panE) in the microorganisms is a further advantage.

It is further advantageous if, where appropriate, the activity of the coaA gene, which is necessary for coenzymeA synthesis, is reduced or (for example in Bacillus species) entirely switched off. This is because, besides coaA, Bacillus contains another gene for this enzymatic function (=coaX). The activity of this coaX gene or of the corresponding enzyme can also be modified, preferably reduced, or even deleted, as long as coaA itself still has an adequate, although reduced, enzymic activity, i.e. the enzymic activity of coaA is not entirely lost. Besides overexpression of the various genes, genetic manipulation of the promoter regions of these genes is also advantageous when this manipulation leads to overexpression of the gene products.

In one embodiment of the present invention, the bacterial strains described in the annex (PCT/US application 0025993), such as, for example, PA 668 and/or derivatives thereof, are used. In a preferred embodiment, the microorganism Bacillus subtilis PA 377, as described in the annex (PCT/US application 0025993), is used according to the invention in the method of the invention. This strain Bacillus subtilis PA 377 was produced as follows:

Starting from the strain Bacillus subtilis 168 (Marburg strain ATCC 6051), which has the genotype trpC2 (Trp⁻), the strain PY79 was generated by transduction of the Trp⁺ marker (from the Bacillus subtilis wild type W23). ΔpanB and ΔpanE1 mutations were introduced into the strain PY79 by classical methods of genetic manipulation (as described, for example, in Harwood, C. R. and Cutting, S. M. (editors), Molecular Biological Methods for Bacillus (1990) John Wiley & Sons, Ltd., Chichester, England).

The resulting strain was transformed with genomic DNA of the Bacillus subtilis strain PA221 (genotype P₂₆panBCD, trpC2 (Trp⁻)) and genomic DNA of the Bacillus subtilis strain PA303 (genotype P₂₆panE1). The resulting strain PA327 has the genotype P₂₆panBCD, P₂₆panE1 and is tryptophan-auxotrophic (Trp⁻).

The pantothenic acid titer reached with the Bacillus subtilis strain PA327 in 10 ml cultures with SVY medium (25 g/l Difco veal infusion broth, 5 g/l Difco yeast extract, 5 g/l Na glutamate, 2.7 g/l ammonium sulfate make up to 740 ml of water, autoclave, then addition of 200 ml of 1M potassium phosphate, pH 7.0 and 60 ml of 50% sterile glucose solution), which was supplemented with 5 g/l β-alanine and 5 g/l α-ketoisovalerate, was up to 3.0 g/l (24 h).

Production of the Bacillus subtilis strain PA221 (genotype P₂₆panBCD, trpC2 (Trp⁻)) is described in the following section:

Classical methods of genetic manipulation were used to clone the panBCD operon of Bacillus starting from a Bacillus subtilis GP275 plasmid library with the aid of the sequence information of the panBCD operon of E. coli (see Merkel et al., FEMS Microbiol. Lett., 143, 1996:247-252). The E. coli strain BM4062 (bir^{ts}) and the information that the Bacillus operon is located in the vicinity of the birA gene was [sic] used for the cloning. The panBCD operon was introduced into a plasmid able to replicate in E. coli. To improve the expression of the panBCD operon, strong, constitutive promoters of Bacillus subtilis phage SP01 (P₂₆) were used, and the ribosome binding site (=RBS) in front of the panB gene was replaced by an artificial RBS. A DNA fragment located immediately upstream of the native panB gene in Bacillus was ligated in front of the P₂₆panBCD cassette on the plasmid. This plasmid was transformed into the Bacillus subtilis strain RL-1 (derivative of Bacillus subtilis 168 (Marburg strain ATCC 6051), genotype trpC2 (Trp⁻)) obtained by classical mutagenesis), and the native panBCD operon was replaced by the p₂₆panBCD operon by homologous recombination. The resulting strain is called PA221 and has the genotype P₂₆panBCD, trpC2 (Trp⁻).

The pantothenic acid titer reached with the Bacillus subtilis strain PA221 in 10 ml cultures with SVY medium which was supplemented with 5 g/l β-alanine and 5 g/l α-ketoisovalerate was up to 0.92 g/l (24 h).

Production of the Bacillus subtilis strain PA303 (genotype P₂₆panE1) is described in the following section: The Bacillus panE sequence was cloned analogously with the aid of the E. coli panE gene sequence. It emerged that two homologs of the panE gene of E. coli exist in B. subtilis, which were referred to as panE1 and panE2. Deletion analyses revealed that the panE gene is responsible for 90% of pantothenic acid production, while deletion of the panE2 gene had no significant effect on pantothenic acid production. Once again, in analogy to the cloning of the panBCD operon, the promoter was replaced by the strong constitutive promoter P₂₆, and the ribosome binding site in front of the panE1 gene was replaced by the artificial binding site. The P₂₆panE1 fragment was cloned into a vector designed so that the P₂₆panE1 fragment was able to integrate into the originally panE1 locus in the genome of Bacillus subtilis. The strain resulting after transformation and homologous recombination is called PA303 and has the genotype P₂₆panE1.

The pantothenic acid titer reached with the Bacillus subtilis strain PA303 in 10 ml cultures with SVY medium supplemented with 5 g/l β-alanine and 5 g/l α-ketoisovalerate was up to 1.66 g/l (24 h).

Further strain construction took place by transformation of PA327 with a plasmid which contained the P₂₆ilvBNC operon and the spectinomycin marker gene. The P₂₆ilvBNC operon integrated into the amyE locus, which was demonstrated by PCR. One transformant was called PA340 (genotype P₂₆panBCD, P₂₆panE1, P₂₆ilvBNC, SpecR, trpC2 (Trp⁻)).

The pantothenic acid titer reached with the Bacillus subtilis strain PA340 in 10 ml cultures with SVY medium which was supplemented only with 5 g/l β-alanine was up to 3.6 g/l (24 h), and that in 10 ml cultures with SVY medium supplemented with 5 g/l β-alanine and 5 g/l α-ketoisovalerate was up to 4.1 g/l (24 h).

In addition, a deregulated ilvD cassette was introduced into the strain PA340. This was done by transforming a plasmid which contains the ilvD gene under the control of the P₂₆ promoter with the artificial RBS2 into PA340. In this case the P₂₆ilvD gene was integrated by homologous recombination into the originally ilvD locus. The resulting strain PA374 has the genotype P₂₆panBCD, P₂₆panE1, P₂₆ilvBNC, P₂₆ilvD, SpecR and trpC2 (Trp⁻).

The pantothenic acid titer reached with the Bacillus subtilis strain PA374 in 10 ml cultures with SVY medium which was supplemented only with 5 g/l β-alanine was up to 2.99 g/l (24 h).

In order to produce pantothenic acid with the strain PA374 without feeding β-alanine, additional copies of the gene panD which codes for aspartate α-decarboxylase were introduced into the strain PA374. This was done by transforming chromosomal DNA of the strain PA401, which is described hereinafter, into PA374. The strain PA377 was obtained by tetracycline selection.

The resulting strain PA377 has the genotype P₂₆panBCD, P₂₆panE1, P₂₆ilvBNC, P₂₆ilvD, SpecR, tetR and trpC2 (Trp⁻).

The pantothenic acid titer reached with the Bacillus subtilis strain PA377 in 10 ml cultures with SVY medium without feeding of precursor was up to 1.31 g/l (24 h).

Production of the Bacillus subtilis strain PA401 (genotype P₂₆panD) is described in the following section:

The Bacillus subtilis panD gene was cloned from the panBCD operon into a vector which harbors the tetracycline marker gene. The P₂₆ promoter and an artificial RBS described above was [sic] cloned in front of the panD gene. A fragment containing the tetracycline marker gene and the P₂₆panD gene was produced by restriction digestion. This fragment was religated and transformed into the strain PA221 described above. The fragment integrated into the genome of the strain PA211 [sic]. The resulting strain PA401 has the genotype P₂₆panBCD, P₂₆panD, tetR and trpC2 (Trp⁻).

The pantothenic acid titer reached with the Bacillus subtilis strain PA401 in 10 ml cultures in SVY medium which was supplemented with 5 g/l of α-ketoisovalerate was up to 0.3 g/l (24 h). The pantothenic acid titer reached in 10 ml cultures with SVY medium supplemented with 5 g/l D-pantoic acid and 10 g/l L-aspartate was up to 2.2 g/l (24 h).

The exact construction of the strains is to be found in the annex PCT/US application 0025993.

With the strain PA377 described above in glucoselimited fermentation in SVY medium (25 g/l Difco veal infusion broth, 5 g/l Difco yeast extract, 5 g/l tryptophan, 5 g/l Na glutamate, 2 g/l (NH₄)₂SO_{4, 10} g/l KH₂PO₄, 20 g/l K₂HPO₄, 0.1 g/l CaCl₂, 1 g/l MgSO₄, 1 g/l sodium citrate, 0.01 g/l FeSO₄*7 H₂O and 1 ml/l of a trace salt solution of the following composition: 0.15 g Na₂MoO₄×2H₂O, 2.5 g H₃BO₃, 0.7 g CoCl₂×6H₂O, 0.25 g CuSO₄×5H₂O, 1.6 g MnCl₂×4H₂O, 0.3 g ZnSO₄×7H₂O, made up to 1 l with water)) on the 10 l scale with continuous feeding of a glucose solution, pantothenic acid concentrations in the fermentation broth of 18-19 g/l (22-25 g/l) is [sic] reached in 36 h (48 h).

It is possible by development of the media, strains and fermentation method to increase the pantothenic acid titers in the fermentation broth to more than 40, 45, 50, 55, 60, 65, 70, 75, 80, 85 and >90 g/l.

It is a considerable advantage of the method of the invention that the fermentation is carried out in a culture medium which, apart from at least one carbon source and nitrogen source, contains no other precursors as starting compounds. This means that biosynthesis of D-pantothenic acid does not depend on feeding with other precursors. Such precursors mean according to the invention substances such as, for example, β-alanine and/or L-aspartate and/or L-valine and/or α-ketoisovalerate and/or combinations thereof.

In a preferred variant of the method of the invention, the fermentation of the D-pantothenic acid-producing organism is carried out in a culture medium which contains at least one carbon source and one nitrogen source as precursor but no β-alanine added to the medium. The independence of the feeding with precursors represents in particular a considerable economic advantage of the method of the invention compared with known methods, because many precursors are very costly.

Examples of carbon sources suitable according to the invention for use in a culture medium for fermentation of the aforementioned organisms are sugars such as starch hydrolyzates (mono-, di-, oligosaccharides), preferably glucose or sucrose, and sugar beet or sugarcane molasses, proteins, protein hydrolyzates, soybean flour, corn steep liquor, fats, free fatty acids, recycled cells from previously performed fermentations or hydrolyzates thereof, and yeast extract. These enumerations are not limiting for the present invention either, just like the following examples of suitable nitrogen sources, such as ammonia, ammonium sulfate, urea, proteins, protein hydrolyzates or yeast extract. The fermentation medium additionally contains mineral salts and/or trace elements, such as [sic] amino acids and vitamins. The exact compositions of many suitable fermentation media are known and available for the skilled worker.

After inoculation of the fermentation medium with a suitable D-pantothenic acid-producing organism with the cell densities known to the skilled worker, the organism is cultivated where appropriate with the addition of an antifoam. The fermentation is managed according to the invention in such a way that when complete it has at least a solids content of the dried fermentation solution of at least 6% by weight and a free D-pantothenic acid content of at least 2% by weight, preferably of at least 4% by weight. For this purpose, the fermentation can be carried out in batch, fed-batch or repeated fed-batch operation while metering in the carbon source, or be operated continuously. The fermentation temperature is 10-70° C., preferably 20-50° C. The fermenter is aerated with oxygen, air or mixtures with nitrogen or other inert gases. The pH is adjusted to a value in the range 4-8, preferably 5-7.5, and regulated where appropriate by metering in suitable bases and/or acids.

The present method is further distinguished in an advantageous manner by the total sugar content being reduced to a minimum by the end of the fermentation because, otherwise, this would impede later drying and/or formulation of the fermentation solution through adhesion. This can be achieved according to the invention by continuing the fermentation for some time after the carbon source has been consumed (on cultivation in batch operation) or after the carbon feed (in a process managed by fed-batch or repeated fed-batch operation) has been stopped and/or regulated so that the concentration of the carbon source is virtually zero (in the case of fed-batch, repeated fed-batch or continuous process management).

This takes place according to the invention by the fermentation being continued after stopping the metering in of the carbon source (e.g. sugar solution) until the dissolved oxygen concentration (pO₂) reaches at least 80%, preferably 90% and particularly preferably 95% of the saturation value in the fermentation solution.

It is further essential for the method of the invention that the fermentation solution can be subjected to drying and/or formulation without carrying out further workup steps. This means that elaborate workup steps to isolate the desired D-pantothenic acid-containing product from the fermentation solution, such as, for example, purification by adsorption on activated carbon, are unnecessary. Removal of the biomass from the fermentation solution is likewise not absolutely necessary, so that the protein content of the product of the invention, i.e. of the D-pantothenic acid-containing animal feed supplement, may have a protein content of up to 50% by weight.

The drying and/or formulation of the fermentation solution takes place by methods known per se, such as, for example, spray drying, spray granulation, fluidized bed drying, fluidized bed granulation, drum drying or spin-flash drying (Ullmann's Encyclopedia of Industrial Chemistry, 6th edition, 1999, electronic release, chapter “Drying of Solid Materials”). The gas inlet temperature for convection drying is in the range 100-280° C., preferably at 120-210° C. The gas outlet temperature is at 50-180° C., preferably at 60-150° C. To adjust a desired particle size distribution and the product properties associated therewith it is possible for fine particles to be removed and recycled. It is also possible for coarse material to be ground in a mill and likewise subsequently recycled. The product of the invention has, for example, a beige to brown color. It moreover contains a residual water content of less than 5% by weight, preferably 1-3% by weight and particularly preferably 0.5-2% by weight. In order to prevent agglomeration of the product, the water content should not exceed 5% by weight. A schematic block flow diagram of the aforementioned method is summarized in FIG. 1.

In one variant of the aforementioned method of the invention, the drying and/or formulation of the fermentation solution is preceded where appropriate by the removal of the biomass from the fermentation solution. This removal can be virtually complete or only partial. Partial removal of the biomass is preferred, it being possible thereby to reduce the protein content to below 10% by weight. To achieve virtually complete removal of the biomass, the solids contents can be removed from the aqueous liquid for example by centrifugation. Based on the dried final product, it is possible in a further variant of the invention even to adjust the protein content to less than 5% by weight. The removed biomass can be used in an advantageous manner for compensating the natural variations, which occur within certain tolerance ranges, in the D-pantothenic acid content in the fermentation solutions from different production batches. For example, after removal of the biomass from a plurality of different batches it is possible to supply a product with a content of D-pantothenate [sic] and/or salts thereof which remains constant through renewed addition of previously removed biomass. This guarantees a product of reproducibly constant quality.

In a further embodiment of the method of the invention it is possible before the drying and/or formulation of the fermentation solution and, where appropriate, after removal of the biomass for the fermentation solution to be concentrated to increase the solids content containing D-pantothenic acid and/or salts thereof. This can be achieved for example by removing water by evaporation which, for reasons of cost, can be carried out where appropriate in a multistage process and can, to avoid harm to the product, be carried out besides atmospheric pressure also in vacuo. A further possibility is to use a membrane method. It is possible to use in this case for example methods such as nano-filtration and/or reverse osmosis. The concentration can take place until the D-pantothenic acid content is from 20 to 50% by weight. The water can, where appropriate, simultaneously be recycled to the fermentation process. This reduces in an advantageous manner the amount of wastewater produced, thus considerably lowering the cost of wastewater treatment. This is depicted diagrammatically in FIG. 2.

In a preferred embodiment of the present invention the removal of biomass and concentration of the remaining fermentation solution are combined, where appropriate with simultaneous recycling of the water. A representation in a block flow diagram is shown in FIG. 3. For this purpose it is possible in order to adjust to a constant content of substance of value in the product in the method of the invention to remove the biomass or a part thereof, e.g. by separation, centrifugation, ultrafiltration, microfiltration or depth-type filtration or combinations after the end of the fermentation. The biomass obtained in this way can in turn be subjected again to further removal of moisture by means of a decanter. The clear effluent from the decanter is then returned to the inlet of the separator. The removal of cells makes it possible to increase the content of D-pantothenic acid in the product or adjust the content to a constant value in which [sic] various fractions are mixed together so that varying contents from the fermentation can also be processed without problems. Further concentration of the fermentation solution can then take place. The contents based on free D-pantothenic acid and/or salts thereof are 20-95% by weight, preferably 30-90% by weight. It is particularly preferred for the resulting product to have a high content of free D-pantothenic acid and/or salts thereof of 60-80% by weight and in particular of more than 80% by weight.

In further variants of the method of the invention it is possible before the drying and/or formulation of the fermentation solution to carry out at least one of the following steps comprising

1) lysis and/or killing of the biomass and/or

2) removal of the biomass from the fermentation solution and/or

3) addition of further additives and/or

4) concentration of the fermentation solution, preferably by removal of water and, where appropriate, simultaneous recycling of the water to the fermentation process and/or

5) combinations of steps 1) to 4).

The present invention thus also relates to a method where the lysis and/or killing of the biomass is carried out while still in the fermentation solution or only after removal of the biomass from the fermentation solution. This can take place for example by a thermal treatment, preferably at 80-200° C. and/or an acid treatment, preferably with sulfuric acid or hydrochloric acid and/or enzymatically, preferably with lysozyme. A block flow diagram for illustration is shown in FIG. 4.

A further embodiment of the method of the invention describes a procedure in which, before the concentration and/or before the drying and/or formulation, further additives and/or mixtures thereof are added to the fermentation solution in order to adjust a uniform content of D-pantothenic acid and/or to improve the properties of the product, such as dusting, flow properties, water-uptake capacity and storage stability. Examples of such additives and/or mixtures thereof may be based on sugars, e.g. lactose or maltodextrin, based on cereals products or legume products, for example ground corn cobs, wheat bran and soybean meal, based on mineral salts, inter alia calcium, magnesium, sodium and potassium salts, and also D-pantothenic acid or salts thereof themselves (D-pantothenic acid salt produced chemically or by fermentation). The addition can take place before the drying and/or during the granulation or formulation step itself. This is illustrated in summary in FIG. 5.

In a further variant of the present invention, a calcium D-pantothenate is produced by adding calcium salts in a step which is as late as possible in the method of the invention, i.e. preferably before and/or during the workup of the fermentation solution, i.e. before and/or during the concentration and/or drying and/or formulation of the fermentation solution (see FIG. 5). In this case the content of calcium ions is adjusted by addition of calcium salts so that about 1 mol of calcium salt are [sic] present per 2 mol of D-pantothenic acid in the formulated final product. It is moreover possible and advantageous to take account of the content of calcium ions already present in the fermentation solution. Calcium salts which can be used are, for example, calcium oxide, calcium hydroxide, calcium hydrogen phosphate, calcium carbonate, calcium sulfate, calcium chloride and/or another calcium salt.

The present invention thus also relates to a method in which, based on the content of D-pantothenic acid in the formulated product, 1 mol of calcium ions are added per 2 mol of D-pantothenic acid in the form of a calcium salt as additive before and/or during the concentration, drying and/or formulation.

A further possibility in another variant of the [lacuna] of the invention is to produce, through the composition of the fermentation medium and, in this connection, in particular the selection of the mineral salts with a specific cation, a product which contains an increased quantity of a selected salt of D-pantothenic acid. For example, it is possible through the use of dipotassium hydrogen phosphate/potassium dihydrogen phosphate buffer even during the fermentation to produce a product which substantially comprises potassium D-pantothenic acid [sic]. Examples of conceivable salts are calcium, potassium, magnesium, sodium or ammonium salts of D-pantothenic acid or any mixtures thereof. A block flow diagram is depicted in FIG. 6.

It is possible according to the invention for all the aforementioned variants, and the procedures shown in FIGS. 1 to 6, to be freely combined.

The present invention further relates to an animal feed supplement produced by one of the methods described above based on a fermentation solution obtained by fermentation of at least one D-pantothenic acid-producing organism, comprising at least free D-pantothenic acid and/or salts thereof in a concentration of at least 30-95% by weight, a total sugar content of 0.1-15% by weight and a protein content of less than 5 to 50% by weight, based on dry matter.

The animal feed supplement of the invention is distinguished by comprising 50-95% by weight, preferably 70-95% by weight, particularly preferably 60-80% by weight and in particular more than 80% by weight of free D-pantothenic acid and/or salts thereof.

The untreated fermentation solution as basis for the animal feed supplement of the invention comprises according to the invention at least 10 g/l, preferably at least 20 g/l and particularly preferably at least 40 g/l D-pantothenate [sic] and/or salts thereof.

The animal feed supplement of the present invention may additionally comprise calcium, potassium, magnesium, sodium and/or ammonium salts of D-pantothenic acid and/or mixtures thereof.

A particular variant of the animal feed supplement of the invention is distinguished by a dry matter composition having at least the following components:

| | | |
|---|---|---|
| a) | free D-pantothenic acid | at least 30-95% by weight |
| | and/or salts thereof | |
| b) | proteins | max. 50% by weight |
| c) | total sugar | max. 15% by weight |
| d) | minerals | max. 20% by weight |

The animal feed supplement may according to the invention comprise a protein content of a maximum of 50% by weight as upper limit and as lower limit less than 10% by weight, preferably less than 7% by weight and particularly preferably of less than 5% by weight. The total sugar content of the animal feed supplement is a maximum of about 15% by weight and may comprise as lower limit less than about 0.1% by weight, with all intermediate stages being conceivable. In terms of its water content, the D-pantothenic acid-containing product of the invention is distinguished by a residual water content of less than 5% by weight, preferably 1-3% by weight and particularly preferably of 0.5-2% by weight.

The present invention further relates to an animal feed supplement comprising inactive, live and/or viable contents of D-pantothenic acid-producing organisms. These are preferably microorganisms, preferably fungi, yeasts and/or bacteria. The animal feed supplement of the invention particularly preferably comprises inactive, live and/or viable contents of fungi of the genus Mucor, yeasts of the genus Saccharomyces and/or bacteria of the Enterobacteriaceae such as E. coli, salmonellae such as Salmonella typhimurium, Proteus vulgaris, pseudomonads such as Pseudomonas matophila [sic], Bacillaceae such as Bacillus subtilis or Bacillus cereus, coryneform bacteria such as Corynebacterium glutamicum or Brevibacterium breve and/or Actinum mycetalis and/or mixtures thereof. Very particular preference is given to bacteria of the genus Bacillus and in this case of the species Bacillus subtilis. The invention likewise encompasses genetically modified and/or transgenic organisms and/or producer strains suitable for producing animal feed supplements. The preceding list is in this connection non-limiting for the present invention.

The invention further includes an animal feed supplement which comprises further additives, preferably based on sugars and/or cereals and/or legumes and/or mineral salts and/or (separately produced produced [sic] chemically and/or by fermentation) D-pantothenic acid and/or salts thereof and/or mixtures thereof.

The animal feed supplement of the invention is further characterized by a formulation with an apparent density of from 0.35 to 0.7 kg/l, preferably 0.4 to 0.6 kg/l. It has moreover according to the invention an average particle diameter in the range 10-2000 μm, preferably 20-1500 μm, particularly preferably 25-1000 μm and most preferably 30-800 μm. It has a beige to brown color. The animal feed supplement of the invention may be in the form of a powder, granules, pellet, provided with a coating (“coated”) and/or combinations thereof. The formulation of the animal feed supplement of the invention, for example by enveloping compounds, serves, for example, to improve the properties of the product, such as dusting, flow properties, water-uptake capacity and storage stability.

The present invention further relates to the use of the animal feed supplement having the properties described above, as addition to animal feed and/or animal feed supplements.

The following examples serve to illustrate the present invention but have no limiting effect:

### EXAMPLE 1

### Production of D-pantothenic Acid-Containing Fermentation Solution with B. subtilis

Aqueous fermentation medium with the following composition was introduced into a laboratory fermenter with a capacity of 14 1 and with a stirrer and gas introducer:

| | |
|---|---|
| Yeast extract | 20 g/l |
| Tryptophan | 5 g/l |
| Ammonium sulfate | 2 g/l |
| Sodium glutamate | 5 g/l |

After the sterilization, the following media components were additionally added:

| | | |
|---|---|---|
| KH₂PO₄ | 10 | g/l |
| K₂HPO₄ × 3H₂O | 20 | g/l |
| Glucose | 10 | g/l |
| MgCl₂ × 6H₂O | 1 | g/l |
| CaCl₂ × 2H₂O | 0.1 | g/l |
| Sodium citrate | 1 | g/l |
| FeSO₄ × 7H₂O | 0.01 | g/l |
| Trace salt | 6 | ml/l |
| solution | | |

The trace salt solution has the following composition: 0.15 g Na₂MoO₄×2H₂O, 2.5 g H₃BO₃, 0.7 g CoCl₂×6H₂O, 0.25 g CuS0₄×5H₂O, 1.6 g MnCl₂×4H₂O, 0.3 g ZnSO₄×7H₂O are made up to 1 l with water.

The trace salt solution is added via sterile filtration. The initial liquid volume is 6 l. The contents listed above are based on this value.

60 ml of inoculation culture (OD₆₀₀=9.5) of Bacillus subtilis PA377 is added to this solution, which is fermented at 37° C. at 200 rpm at an aeration rate of 12 l/min. This strain is described in the annex in PCT/US application 0025993.

4.5 l of a sterile aqueous solution were metered in over the course of 72 h. The composition was:

| | | |
|---|---|---|
| Glucose | 400 | g/l |
| CaCl₂ × 2H₂O | 0.4 | g/l |
| Yeast extract | 25 | g/l |

During the fermentation, the pH was kept at 7.2 by metering of ammonia into the fermenter inlet air or of phosphoric acid. Ammonia also serves as nitrogen source for the fermentation. The speed of the stirrer was controlled by keeping the dissolved oxygen content at 30% of the saturation value. After metering in of the carbon source was stopped, the fermentation was continued until the dissolved oxygen content (pO2) had reached a value of 95% of the saturation value. The fermentation was then stopped and the organism was killed thermally. This was done by keeping the fermentation solution at 100° C. at [sic] 1 h. The killing was demonstrated by plating out. The concentration of D-pantothenic acid when stopped after 72 h was 28 g/l.

It is also possible in an analogous way to produce fermentation broths which have pantothenic acid titers of higher than 20, 25, 30, 35, 40, 45, 50, 55, 60, 65, 70, 75, 80, 85 and >90 g/l without feeding in β-alanine.

In this fermentation, the counter ion of D-pantothenic acid was adjusted by using a dipotassium hydrogen phosphate/potassium dihydrogen phosphate buffer in the fermentation so that the potassium salt of D-pantothenic acid, i.e. potassium D-pantothenate, is substantially obtained.

### EXAMPLE 2

### Cell Removal and Drying of D-pantothenic Acid-Containing Fermentation Solution from E. coli

D-pantothenic acid-containing fermentation solution is produced as in example 1 of U.S. Pat. No. 6,013,492 with Escherichia coli IFO 814/pFV 31. Subsequently, gas is introduced into the fermentation further until the carbon source is completely consumed, until the dissolved oxygen content (pO2) has risen to above 80%. The cells are subsequently removed with a separator. The D-pantothenic acid content in this case is 38.5 g/l. After evaporation with a rotary evaporator in vacuo (<100 mbar) to a solids content of about 45% by weight, the concentrate is dried in a laboratory spray dryer under the following conditions:

| | |
|---|---|
| Gas inlet temperature: | 100-250° C. |
| Gas outlet temperature: | 60-150° C. |

A free-flowing product with an average particle diameter of 20-300 μm is obtained.

### EXAMPLE 3

### Drying of D-pantothenic Acid-Containing Fermentation Solution from B. subtilis with Additional Removal of the Biomass

Fermentation solution (1 l) from example 1 is dried in a laboratory spray dryer under the following conditions:

| | |
|---|---|
| Gas inlet temperature: | 100-250° C. |
| Gas outlet temperature: | 60-150° C. |

A free-flowing product with an average particle diameter of 20-300 μm is obtained.

### EXAMPLE 4

### Removal of Cells and Drying of D-pantothenic Acid-Containing Fermentation Solution with Lactose as Additive

The biomass from fermentation solution (1 l) from example 1 is centrifuged in a centrifuge. The supernatant is mixed with 30 g of lactose and dried in a laboratory spray dryer under the following conditions:

| | |
|---|---|
| Gas inlet temperature: | 100-250° C. |
| Gas outlet temperature: | 60-150° C. |

A free-flowing product with a particle diameter of 40-500 μm and a free D-pantothenic acid content of >30% by weight is obtained.

### FIG. 5

### Drying of D-pantothenic Acid-Containing Fermentation Solution with Chemically produced Calcium D-pantothenate as Additive, e.g. to Adjust a Fixed Concentration of D-pantothenic Acid in the Final Product

The biomass from fermentation solution (1 l) from example 1 is centrifuged in a centrifuge. The supernatant is mixed with 100 g of chemically produced calcium D-pantothenate and dried in a laboratory spray dryer under the following conditions:

| | |
|---|---|
| Gas inlet temperature: | 100-250° C. |
| Gas outlet temperature: | 60-150° C. |

A free-flowing product with a particle diameter of 40-500 μm and a free D-pantothenic acid content of >60% by weight is obtained.

### EXAMPLE 6

### Adjustment of the Calcium Content in Formulations of D-pantothenic Acid from Fermentation Solutions

A D-pantothenic acid-containing fermentation solution contains after removal of the biomass a solids content of 95 g/l, of which 70 g/l D-pantothenic acid and 25 g/l other solids (salts, biomass residues, other solid constituents depending on the fermentation medium, no calcium ions).

The D-pantothenic acid contents resulting in the formulated product on addition of various calcium salts are indicated below. In these cases, the calcium content was adjusted so that 1 mol of calcium ions are present per 2 mol of D-pantothenic acid.

| Added calcium salt | D-pantothenic acid content |
|---|---|
| (1 mol per 2 mol of | in the formulated product in |
| D-pantothenic acid) | [% by weight] |
| no addition | 74 |
| Ca(OH)₂ | 66 |
| CaO | 67 |
| CaSO₄ | 57 |
| CaHPO₄ | 60 |
| CaCO₃ | 63 |
| Ca(Cl)₂ | 62 |

### DESCRIPTION OF THE FIGURES

FIG. 1: Block flow diagram of a method for producing a D-pantothenic acid salt by drying and/or formulation of the fermentation solution.

FIG. 2: Block flow diagram of a method for producing a D-pantothenic acid salt by drying and/or formulation of the fermentation solution, with additional concentration step and recycling of the removed water into the fermentation.

FIG. 3: Block flow diagram of a method for producing a D-pantothenic acid salt by drying and/or formulation of the fermentation solution with cell removal.

FIG. 4: Block flow diagram of a method for producing a D-pantothenic acid salt in which lysis of the cells and/or killing of the organism takes place after the fermentation (A) and/or after the cell removal (B).

FIG. 5: Block flow diagram of a method for producing a D-pantothenic acid salt in which additives are added for the drying.

FIG. 6: Block flow diagram of a method for producing a D-pantothenic acid salt in which the desired cation is achieved by the selection of the salts employed in the fermentation medium.

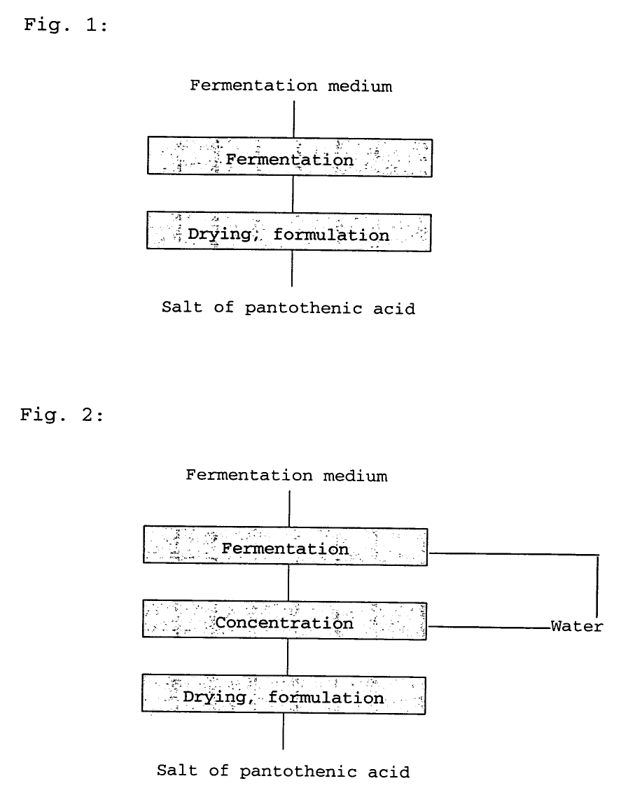

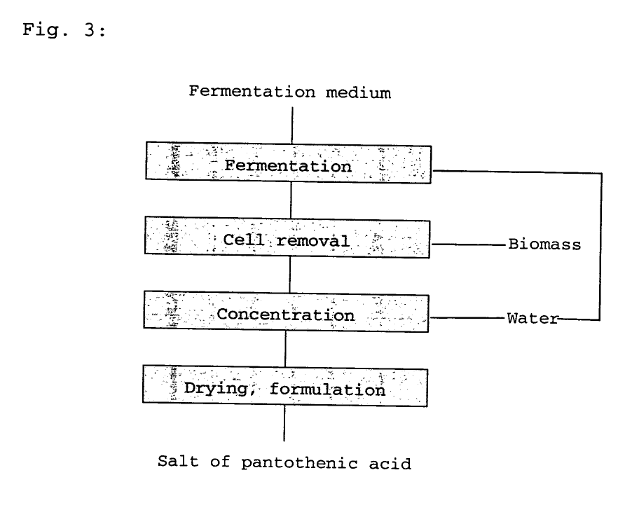

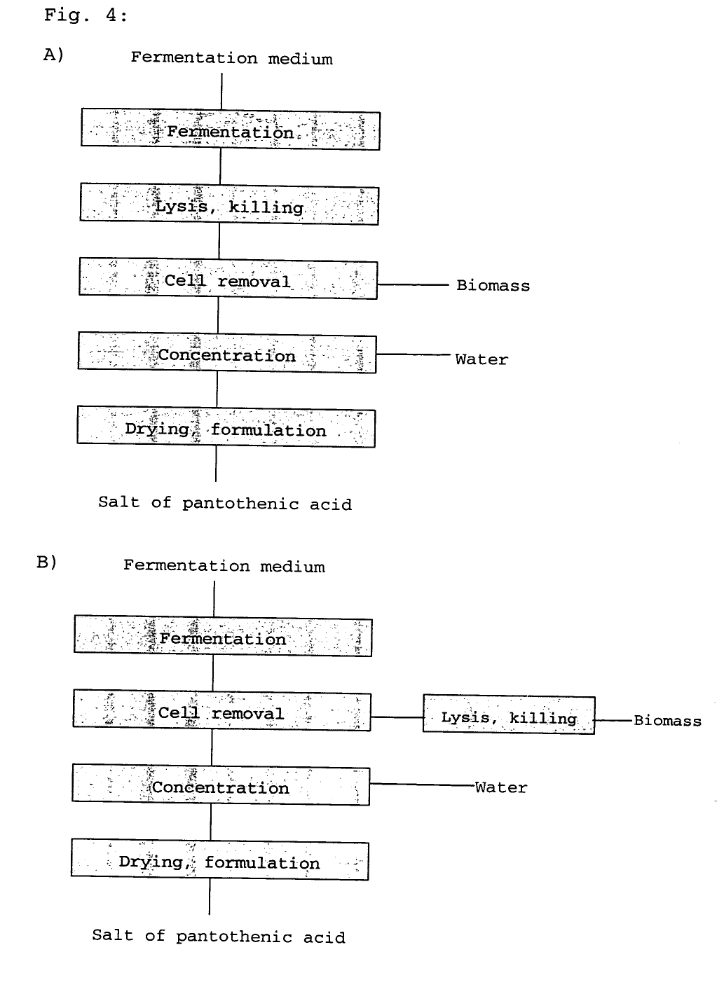

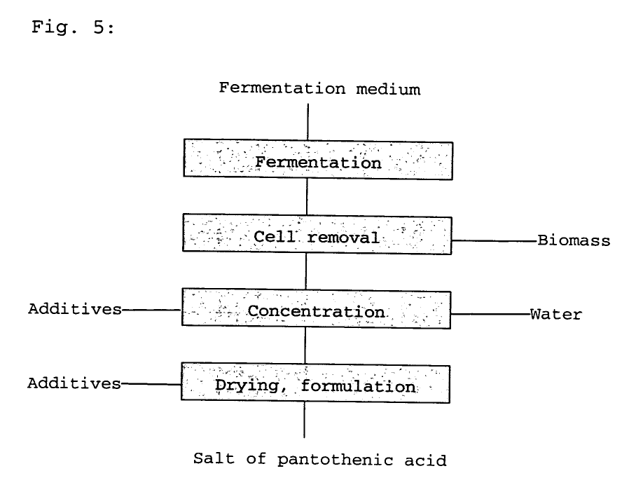

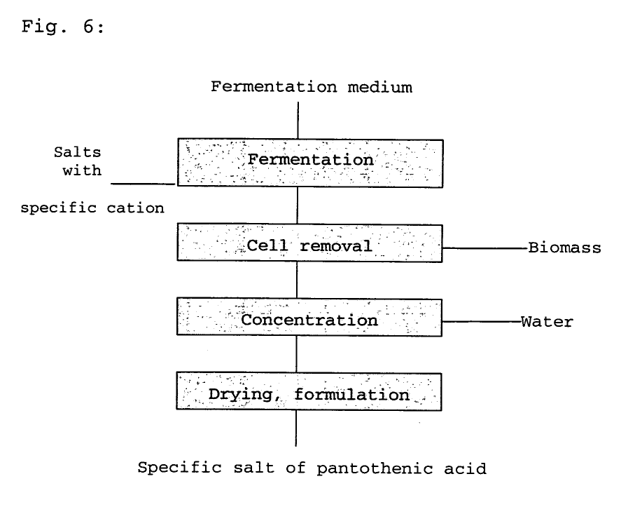

1. A method for the production of an animal feed supplement containing free D-pantothenic acid and/or salts thereof, where
a) a D-pantothenic acid-producing organism is fermented in a culture medium containing at least one carbon source and one nitrogen source without feeding with other precursors and
b) the fermentation solution containing D-pantothenic acid and/or salts thereof is subjected, without carrying out further workup steps, to a drying and/or formulation.

2. The method as claimed in claim 1, characterized in that the fermentation is carried out until a solids content of at least 6% by weight, preferably of 7-25% by weight and/or a D-pantothenic acid content of at least 2-15% by weight, preferably 4-15% by weight, is reached.

3. The method as claimed in either of claims 1 or 2, characterized in that the metering in of the carbon source is stopped and/or regulated in such a way that a concentration of virtually zero is adjusted and/or the fermentation is continued until a dissolved oxygen concentration of at least 80%, preferably 90% and particularly preferably 95% of the saturation value is reached in the fermentation solution.

4. The method as claimed in any of claims 1 to 3, characterized in that a D-pantothenic acid-producing organism whose pantothenic acid (pan) and/or isoleucine-valine (ilv) biosynthesis and/or asparate [sic] α-decarboxylase is deregulated is employed.

5. The method as claimed in any of claims 1 to 4, characterized in that the biomass is removed where appropriate from the fermentation solution before the drying and/or formulation.

6. The method as claimed in any of claims 1 to 5, characterized in that the fermentation solution is concentrated by removal of water with, where appropriate, simultaneous recycling of the water to the fermentation process before the drying and/or formulation and, where appropriate, after the removal of the biomass.

7. The method as claimed in any of claims 1 to 6, characterized in that, before the drying and/or formulation, at least one of the following steps comprising
1) lysis and/or killing of the biomass and/or
2) removal of the biomass from the fermentation solution and/or
3) addition of further additives and/or
4) concentration of the fermentation solution, preferably by removal of water and, where appropriate, simultaneous recycling of the water to the fermentation process and/or
5) combinations of steps 1) to 4), is carried out.

8. The method as claimed in any of claims 1 to 7, characterized in that the lysis and/or killing of the biomass is carried out while still in the fermentation solution or only after removal of the biomass from the fermentation solution.

9. The method as claimed in any of claims 1 to 8, characterized in that further additives and/or mixtures of additives are added to the fermentation solution before and/or during the concentration, drying and/or formulation.

10. The method as claimed in any of claims 1 to 9, characterized in that, based on the D-pantothenic acid content in the formulated product, 1 mol of calcium ions are added per 2 mol of D-pantothenic acid in the form of a calcium salt as additive before and/or during the concentration, drying and/or formulation.

11. An animal feed supplement based on a fermentation solution obtained by fermentation of at least one D-pantothenic acid-producing organism, comprising at least free D-pantothenic acid and/or salts thereof in a concentration of at least 30-95% by weight, a total sugar content of 0.1-15% by weight and a protein content of less than 5 to 50% by weight, based on dry matter.

12. The animal feed supplement as claimed in claim 11, characterized in that it comprises 50-95% by weight, preferably 70-95% by weight, particularly preferably 60-80% by weight and in particular more than 80% by weight of free D-pantothenic acid and/or salts thereof.

13. The animal feed supplement as claimed in either of claims 11 or 12, characterized in that the untreated fermentation solution comprises at least 10 g/l, preferably at least 20 g/l and particularly preferably at least 40 g/l D-pantothenate [sic] and/or salts thereof.

14. The animal feed supplement as claimed in any of claims 11 to 13, characterized in that it comprises calcium, potassium, magnesium, sodium and/or ammonium salts of D-pantothenic acid and/or mixtures thereof.

15. The animal feed supplement as claimed in any of claims 11 to 14, characterized by a dry matter composition having at least the following components:

| | | |
|---|---|---|
| a) | free D-pantothenic acid | at least 30-95% by weight |
| | and/or salts thereof | |
| b) | proteins | max. 50% by weight |
| c) | total sugar | max. 15% by weight |
| d) | minerals | max. 20% by weight |

16. The animal feed supplement as claimed in any of claims 11 to 15, comprising a protein content of less than 10% by weight, preferably less than 7% by weight and particularly preferably of less than 5% by weight.

17. The animal feed supplement as claimed in any of claims 11 to 16, comprising a total sugar content of less than 10% by weight, preferably of about 0.5% by weight and particularly preferably of about 0.1% by weight.

18. The animal feed supplement as claimed in any of claims 11 to 17, comprising a residual water content of less than 5% by weight, preferably 1-3% by weight and particularly preferably of 0.5-2% by weight.

19. The animal feed supplement as claimed in any of claims 11 to 18, characterized in that it comprises inactive, live and/or viable contents of D-pantothenic acid-producing organisms.

20. The animal feed supplement as claimed in any of claims 11 to 19, characterized in that it comprises inactive, live and/or viable contents of microorganisms, preferably fungi, yeasts and/or bacteria.

21. The animal feed supplement as claimed in any of claims 11 to 20, characterized in that [lacuna] comprises inactive, live and/or viable contents of fungi of the genus Mucor, yeasts of the genus Saccharomyces and/or bacteria of the families of Enterobacteriaceae, salmonellae, pseudomonads, Bacillaceae, coryneform bacteria and/or of the genus Proteus and/or Actinum and/or mixtures thereof.

22. The animal feed supplement as claimed in any of claims 11 to 21, characterized in that it comprises further additives, preferably based on sugars and/or cereals and/or legumes and/or mineral salts and/or D-pantothenic acid, salts thereof and/or mixtures thereof.

23. The animal feed supplement as claimed in any of claims 11 to 22, characterized in that it is in the form of a formulation with an apparent density of 0.35-0.7 kg/l, preferably 0.4-0.6 kg/l.

24. The animal feed supplement as claimed in any of claims 11 to 23, characterized in that it has an average particle diameter in the range 10-2000 μm, preferably 20-1500 μm, particularly preferably 25-1000 μm and most preferably 30-800 μm.

25. The animal feed supplement as claimed in any of claims 11 to 24, characterized in that it is in the form of a powder, granules, pellet, provided with a coating and/or combinations thereof.

26. The use of the animal feed supplement as claimed in any of claims 11 to 25, as addition to animal feed and/or animal feed supplements.
